(19) United States
(12) Patent Application Publication
(10) Pub. No.: US 2024/0187126 A1
(43) Pub. Date: Jun. 6, 2024

(54) SYSTEMS AND METHODS FOR ADAPTIVE SRB RESOURCE HANDLING

(71) Applicant: RAKUTEN MOBILE, INC., Tokyo (JP)

(72) Inventor: Sandeep Mani TRIPATHI, Tokyo (JP)

(73) Assignee: RAKUTEN MOBILE, INC., Tokyo (JP)

(21) Appl. No.: 17/796,170

(22) PCT Filed: Jun. 30, 2022
(86) PCT No.: PCT/US2022/035653

§ 371 Date: Jul. 28, 2022

(51) Int. Cl. H04L 1/00

(52) U.S. Cl. CPC H04L 1/0009; H04L 1/0026

(57) ABSTRACT

A method for adaptive signal radio bearer (SRB) resource handling by a radio access network (RAN) node includes: sending a first message to a user equipment (UE); receiving a second message from the UE in response to the first message, the second message including one or more parameters indicating a radio frequency (RF) condition between the RAN node and the UE, the RF condition reported by the UE; adjusting a code rate for the UE based at least in part on the RF condition between the RAN node and the UE; generating a SRB message using the adjusted code rate; and sending the SRB message to the UE or to one or more other UEs.

### 1. FIELD

Apparatuses and methods consistent with example embodiments of the present disclosure relate to adaptively handling resources in a radio access network (RAN). The adaptive resource handling may may be performed using a signal radio bearer (SRB) message by a node of the RAN, to determine a code rate for communication between the node and a user equipment.

### 2. DESCRIPTION OF RELATED ART

In related art telecommunications standards (e.g., 3GPP specifications for LTE, 5G, etc.), in order for a radio access network (RAN) node to provide a service to a user equipment (UE), the service has to be associated with a radio bearer. For example, the node may send a signaling radio bearer (SRB) message to the UE. The SRB message may include information used for communication between the node and the UE, such as, a modulation and coding scheme (MCS), number of physical resource blocks (PRBs), and a number of layers. For example, the node may determine a code rate to use for communication with the UE, and the node may determine the MCS, number of PRBs, and number of layer values that correspond to the determined code rate. However, the code rate determined by the node is based on a predetermined static value. For example, the code rate may be fixed by an operator or administrator. Even if a radio frequency condition of an environment may support a higher code rate, or if the radio frequency condition of the environment may only support a lower code rate, the code rate used by the node remains the same.

### SUMMARY

According to embodiments, systems and methods are provided for a system to enable adaptively handle resources used by a radio access network (RAN) node for signal radio bearer (SRB) messages.

According to aspects of one or more example embodiments, a method for adaptive signal radio bearer (SRB) resource handling by a radio access network (RAN) node includes: sending a first message to a user equipment (UE); receiving a second message from the UE in response to the first message, the second message including one or more parameters indicating a radio frequency (RF) condition between the RAN node and the UE, the RF condition reported by the UE; adjusting a code rate for the UE based at least in part on the RF condition between the RAN node and the UE; generating a SRB message using the adjusted code rate; and sending the SRB message to the UE or to one or more other UEs.

The adjusting the code rate for the UE, based at least in part on the RF condition reported by the UE, may include: adjusting the code rate for the UE to a first code rate, in response to determining that the RF condition exceeds a first threshold; adjusting the code rate for the UE to a second code rate, in response to determining that the RF condition exceeds a second threshold and is less than or equal to the first threshold; and adjusting the code rate for the UE to a third code rate, in response to determining that the RF condition exceeds a third threshold and is less than or equal to the second threshold.

The adjusting the code rate for the UE, based at least in part on the RF condition reported by the UE, may include: determining a RF condition threshold that is less than the RF condition reported by the UE; determining a code rate corresponding to the RF condition threshold; and adjusting the code rate for the UE to the code rate corresponding to the RF condition threshold.

The adjusting the code rate for the UE, based at least in part on the RF condition reported by the UE, may include: determining a signaling message error rate for a cell corresponding to the RAN node; increasing the code rate by a predetermined increment, in response to determining that the signaling message error rate for the cell is less than a minimum error rate and the code rate is less than or equal to a maximum code rate; and decreasing the code rate by a predetermined decrement, in response to determining that the signaling message error rate for the cell is greater than a maximum error rate and the code rate is greater than a minimum code rate.

The determining the signaling message error rate for the cell corresponding to the RAN node may include: receiving a plurality of second messages from a plurality of UEs; and determining a ratio of a number of second messages that include a NACK parameter to a total number of second messages received.

The one or more parameters in the second message may include at least a first parameter representing a reference signal received power (RSRP), and the RF condition between the RAN node and the UE may be based at least in part on the first parameter.

The one or more parameters in the second message may include at least a second parameter representing channel quality information (CQI) and a third parameter representing a rank indicator (RI), and the first parameter is a function of the second parameter and the third parameter.

According to aspects of one or more example embodiments, an apparatus for performing adaptive signal radio bearer (SRB) resource handling by a radio access network (RAN) node includes: a memory storing instructions; and at least one processor configured to execute the instructions to: send a first message to a user equipment (UE); receive a second message from the UE in response to the first message, the second message including one or more parameters indicating a radio frequency (RF) condition between the RAN node and the UE, the RF condition reported by the UE; adjust a code rate for the UE based at least in part on the RF condition between the RAN node and the UE; generate a SRB message using the adjusted code rate; and send the SRB message to the UE or to one or more other UEs.

The adjusting the code rate for the UE, based at least in part on the RF condition reported by the UE, may include: adjusting the code rate for the UE to a first code rate, in response to determining that the RF condition exceeds a first threshold; adjusting the code rate for the UE to a second code rate, in response to determining that the RF condition exceeds a second threshold and is less than or equal to the first threshold; and adjusting the code rate for the UE to a third code rate, in response to determining that the RF condition exceeds a third threshold and is less than or equal to the second threshold.

The adjusting the code rate for the UE, based at least in part on the RF condition reported by the UE, may include: determining a RF condition threshold that is less than the RF condition reported by the UE; determining a code rate corresponding to the RF condition threshold; and adjusting the code rate for the UE to the code rate corresponding to the RF condition threshold.

The adjusting the code rate for the UE, based at least in part on the RF condition reported by the UE, may include: determining a signaling message error rate for a cell corresponding to the RAN node; increasing the code rate by a predetermined increment, in response to determining that the signaling message error rate for the cell is less than a minimum error rate and the code rate is less than or equal to a maximum code rate; and decreasing the code rate by a predetermined decrement, in response to determining that the signaling message error rate for the cell is greater than a maximum error rate and the code rate is greater than a minimum code rate.

The determining the signaling message error rate for the cell corresponding to the RAN node may include: receiving a plurality of second messages from a plurality of UEs; and determining a ratio of a number of second messages that include a NACK parameter to a total number of second messages received.

The one or more parameters in the second message may include a at least a first parameter representing a reference signal received power (RSRP), and the RF condition between the RAN node and the UE may be based at least in part on the first parameter.

The one or more parameters in the second message may include at least a second parameter representing channel quality information (CQI) and a third parameter representing a rank indicator (RI), and the first parameter is a function of the second parameter and the third parameter.

According to aspects of one or more example embodiments, a non-transitory computer-readable medium for storing computer readable program code or instructions for carrying out operations, when executed by a processor, for adaptive signal radio bearer (SRB) resource handling by a radio access network (RAN) node includes operations for: sending a first message to a user equipment (UE); receiving a second message from the UE in response to the first message, the second message including one or more parameters indicating a radio frequency (RF) condition between the RAN node and the UE, the RF condition reported by the UE; adjusting a code rate for the UE based at least in part on the RF condition between the RAN node and the UE; generating a SRB message using the adjusted code rate; and sending the SRB message to the UE or to one or more other UEs.

The adjusting the code rate for the UE, based at least in part on the RF condition reported by the UE, may include: adjusting the code rate for the UE to a first code rate, in response to determining that the RF condition exceeds a first threshold; adjusting the code rate for the UE to a second code rate, in response to determining that the RF condition exceeds a second threshold and is less than or equal to the first threshold; and adjusting the code rate for the UE to a third code rate, in response to determining that the RF condition exceeds a third threshold and is less than or equal to the second threshold.

The adjusting the code rate for the UE, based at least in part on the RF condition reported by the UE, may include: determining a RF condition threshold that is less than the RF condition reported by the UE; determining a code rate corresponding to the RF condition threshold; and adjusting the code rate for the UE to the code rate corresponding to the RF condition threshold.

The adjusting the code rate for the UE, based at least in part on the RF condition reported by the UE, may include: determining a signaling message error rate for a cell corresponding to the RAN node; increasing the code rate by a predetermined increment, in response to determining that the signaling message error rate for the cell is less than a minimum error rate and the code rate is less than or equal to a maximum code rate; and decreasing the code rate by a predetermined decrement, in response to determining that the signaling message error rate for the cell is greater than a maximum error rate and the code rate is greater than a minimum code rate.

The determining the signaling message error rate for the cell corresponding to the RAN node further comprises: receiving a plurality of second messages from a plurality of UEs; and determining a ratio of a number of second messages that include a NACK parameter to a total number of second messages received.

The one or more parameters in the second message may include a at least a first parameter representing a reference signal received power (RSRP), and the RF condition between the RAN node and the UE may be based at least in part on the first parameter.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates adaptive signal radio bearer (SRB) resource handling, in accordance with one or more example embodiments;

FIG. 2 illustrates a flowchart of a method for adaptive SRB resource handling, in accordance with one or more example embodiments;

FIG. 3 illustrates a flowchart of a method for adjusting a code rate, in accordance with one or more example embodiments;

FIG. 4 illustrates a flowchart of a method for adjusting a code rate, in accordance with one or more example embodiments;

FIG. 5 illustrates a diagram of components of one or more devices, in accordance with one or more example embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

As set forth above, the related art disadvantageously determines a fixed code rate for communication between a radio access network (RAN) node and a user equipment (UE) based on a predetermined static value. Even if a radio frequency condition of an environment may support a higher code rate, or if the radio frequency condition of the environment may only support a lower code rate, the code rate used by the node remains fixed. As such, when the RF condition is good, the resources used to communicate using the fixed code rate may be excessive and may result in lower efficiency. When the RF condition is poor, the resources used to communicate using the fixed code rate may be insufficient and may cause packet loss and one or more retransmissions that result in lower efficiency.

Example embodiments provide a system and method that performs adaptive resource handling using a signal radio bearer (SRB) message. For instance, a RAN node (e.g., gNB) may determine a radio frequency (RF) condition of an environment between the node and a UE, based at least in part on prior communication with the UE, and adjust a code rate used for communication with the UE based on the determined RF condition. If the RF condition is good, then the node can increase the code rate. If the RF condition is poor, then the node may decrease the code rate. The node may generate a SRB message using the adjusted code rate, and may send the SRB message to the UE in order to communicate the adjusted code rate to the UE. By performing adaptive resource handling, improved efficiency may be achieved in both good RF conditions and poor RF conditions.

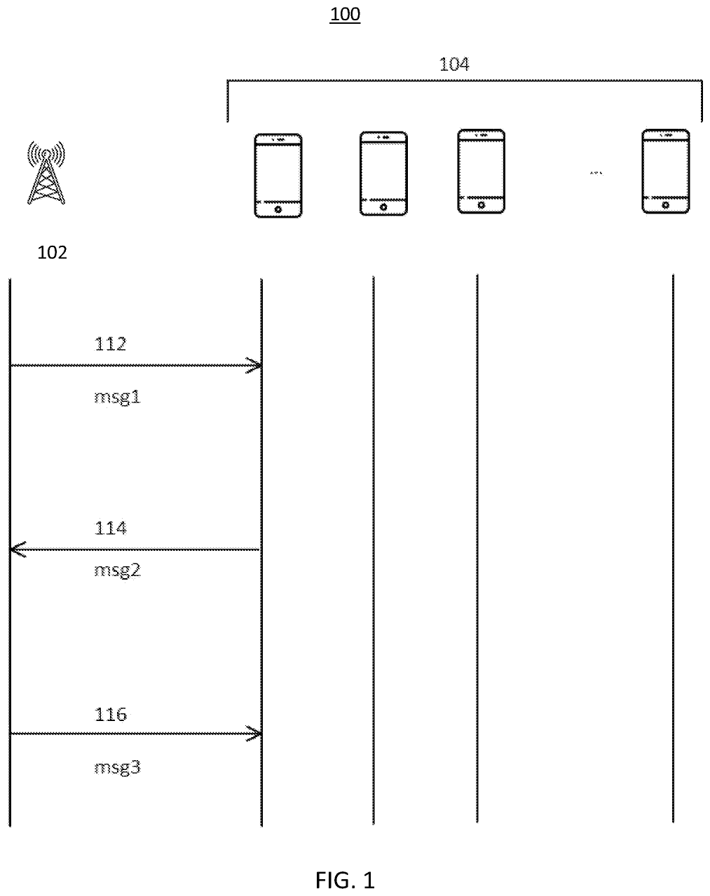

FIG. 1 illustrates adaptive signal radio bearer (SRB) resource handling, in accordance with one or more example embodiments. Referring to FIG. 1, a RAN node 102 (e.g., gNB) and a UE 104 may operate in an environment 100. The UE 104 may be one of a plurality of user equipment that may communicate with the node 102. The node 102 may generate a first message 112 (“msg1”) based on a first code rate. The first message 112 may include, for example, a data message or a signaling message. The first message 112 may indicate the first code rate to the UE. For example, the node 102 may generate the first message 112 using a MCS, number of PRB, and number of layers that correspond to the first code rate.

The node 102 may send the first message 112 to the UE 104. In response to receiving the first message 112 from the node 102, the UE 104 may generate a second message 114 (“msg2”) based at least in part on the first message 112. For example, if the UE 104 successfully receives and decodes the first message 112, then the second message 114 may include an acknowledgement (e.g., ACK). If the UE 104 receives the first message 112 and cannot successfully decode the first message 112, then the second message 114 may include a negative acknowledgement (e.g., NACK).

The UE 104 may generate the second message 114 based at least in part on a RF condition between the node 102 and the UE 104. For example, the second message 114 may include reference signal received power (RSRP) value that corresponds to the first message 112. The RSRP value may be based on a channel quality index (CQI) value and a rank indicator (RI) value. In some implementations, the second message 114 may include the CQI and RI values in addition to the RSRP value. In some implementations, the second message 114 may include upload data that the UE 104 uploads to the node 102 via the second message 114.

The UE 104 may send the second message 114 to the node 102. In response to receiving the second message 114 from the UE 104, the node 102 may determine a RF condition of the environment between the node 102 and the UE 104. The node 102 may determine the RF condition based at least in part on the second message 114. For example, the node may determine if the RSRP value in the second message 114 is above a first threshold value or below a second threshold value. If the RSRP value is above the first threshold, the node 102 may determine that the RF condition between the node 102 and the UE 104 is good. If the RSRP value is below the second threshold, the node 102 may determine that the RF condition between the node 102 and the UE 104 is poor. In some implementations, the first and second threshold may be the same.

The node 104 may adjust the code rate for communication with the UE 104 based at least in part on the RF condition determined by the node 102. For example, if the RSRP value in the second message 114 is above the first threshold, then the node 104 may adjust the code rate by setting it to a first user code rate CRTh1. If the RSRP value in the second message 114 is below the first threshold and above the second threshold, then the node 104 may adjust the code rate by setting it to a second user code rate CRTh2. If the RSRP value in the second message 114 is below the second threshold and above a third threshold, then the node 104 may adjust the code rate by setting it to a third user code rate CRTh3. If the RSRP value in the second message 114 is below the third threshold, then the node 104 may adjust the code rate by setting it to a fourth user code rate CRTh4. The user code rates CRTh1, CRTh2, CRTh3, and CRTh4 may each be initialized to a predetermined value.

In some implementations, the node 102 may determine a block error rate (BLER) associated with one or more SRB messages sent by the node 102 to one or more UE. For example, the node 102 may send an SRB message as the first message 112 to the UE 104. When the node 102 receives the second message 114 from the UE 104, the node 102 determines whether the second message 114 includes an ACK or a NACK corresponding to the first message 112. If the second message 114 includes an ACK, the node 102 may increment a ACK count value in memory. If the second message 114 includes a NACK, then node 102 may increment a NACK count value in memory. If the node 102 sends the first message 112, and the UE 104 does not receive the first message 112, then the node 102 may not receive the second message 114 from the UE 104. If the node 102 does not receive the second message 114 from the UE 104 within a set time window from when the first message 112 was sent to the UE 104, then the node 102 may increment the NACK count value. The node 102 may determine the current BLER based on the ACK count value and the NACK count value. For example, the node 102 may determine the BLER as a ratio of the number of NACKs received to a combined number of ACKs and NACKs received.

The node 102 may adjust the code rate for communication with the UE 104 based at least in part on the BLER determined by the node 102. For example, if the BLER is below a first threshold error rate, the node 102 may increase the code rate. If the BLER is above a second threshold error rate, the node 102 may decrease the code rate.

The node 102 may generate a third message 116 (“msg3”) using the adjusted code rate (a second code rate). For example, the node 102 may generate a SRB message using the second code rate. The third message 116 may include one or more parameters associated with the second code rate. For example, the node 102 may generate the third message 116 using a MCS, number of PRB, and number of layers that correspond to the second code rate. The node 102 may send the third message 116 to the UE 104 in order to indicate the second code rate to the UE 104.

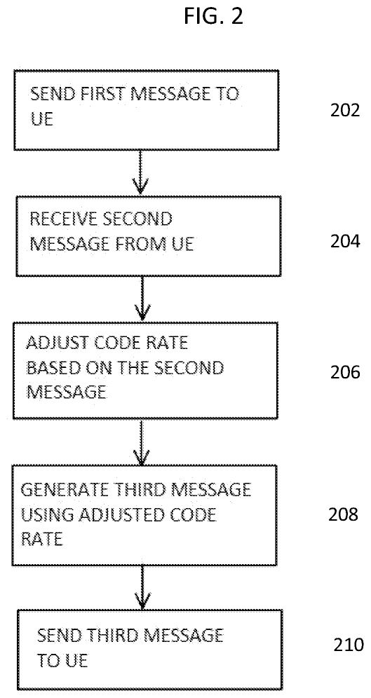

FIG. 2 illustrates a flowchart of a method for adaptive SRB resource handling, in accordance with one or more example embodiments. Referring to FIG. 2, at operation 202, the node 102 may send a first message 112 to a UE 104. For example, the node 102 may send a data message or a signaling message to a first UE. The first message 112 may indicate a first code rate for communication between the node 102 and the first UE. For example, the first message 112 may include a MCS, number of PRB, and number of layers that correspond to the first code rate.

At operation 204, the node 102 may receive a second message 114 from the UE 104. The UE 104 may generate the second message 114 based at least in part on the first message 112 and a RF condition between the node 102 and the UE 104. For example, the first UE may generate the second message 114 based on if the first message 112 is successfully received and decoded, or not. If the first UE receives the first message 112 and may decode the first message 112, then the first UE may generate the second message 114 to include an ACK corresponding to the first message 112. If the first UE receives the first message 112 and cannot decode the first message 112, then the first UE may generate the second message 114 to include a NACK corresponding to the first message 112. If the first UE does not receive the first message 112, then the first UE may not generate and send the second message 114. As another example, the first UE may generate the second message 114 to include a RSRP value that corresponds to the first message 112. The RSRP value may be based on CQI value and a RI value. In some implementations, the first UE may generate the second message 114 to include the CQI and RI values in addition to the RSRP value. In some implementations, the first UE may generate the second message 114 to include upload data for uploading from the first UE to the node 102 via the second message 114.

At operation 206, the node 102 may adjust a code rate based at least in part on the second message 114. In some implementations, the node 102 may adjust the code rate based at least in part on a RF condition indicated in the second message 114, and a BLER associated with one or more SRB messages sent by the node 102. The node 102 may determine the RF condition between the node 102 and the UE 104 based at least in part on the RSRP value in the second message 114. For example, if the RSRP value in the second message 114 is above a first threshold Th1, then the node 104 may adjust the code rate by setting it to a first user code rate CRTh1. If the RSRP value in the second message 114 is equal to or below Th1 and above a second threshold Th2, then the node 104 may adjust the code rate by setting it to a second user code rate CRTh2. If the RSRP value in the second message 114 is equal to or below Th2 and above a third threshold Th3, then the node 104 may adjust the code rate by setting it to a third user code rate CRTh3. If the RSRP value in the second message 114 is equal to or below Th3, then the node 104 may adjust the code rate by setting it to a fourth user code rate CRTh4.

The node 102 may determine the BLER based on at least in part on a number of ACKs and a number of NACKs in one or more second messages 114. For example, the node 102 may send an SRB message as the first message 112 to the first UE. When the node 102 receives the second message 114 from the first UE, the node 102 determines whether the second message 114 includes an ACK or a NACK corresponding to the first message 112. If the second message 114 includes an ACK, the node 102 may increment a ACK count value in memory. If the second message 114 includes a NACK, then node 102 may increment a NACK count value in memory. If the node 102 sends the first message 112, and the first UE does not receive the first message 112, then the node 102 may not receive the second message 114 from the first UE. If the node 102 does not receive the second message 114 from the first UE within a set time window from when the first message 112 was sent to the first UE, then the node 102 may increment the NACK count value. The node 102 may determine the current BLER based on the ACK count value and the NACK count value. For example, the node 102 may determine the BLER as a ratio of the number of NACKs received to a combined number of ACKs and NACKs received. If the BLER is below a first threshold error rate minErrRate, and the code rate is less than a maximum code rate CRThmax, the node 102 may increase the code rate. If the BLER is above a second threshold error rate maxErrRate, and the code rate is greater than a minimum code rate CRThmin, the node 102 may decrease the code rate. In some implementations, the node 102 may increase the code rate by a threshold value Thinc, and the node 102 may decrease the code rate by a threshold value Thdec. The values for CRThmax, CRThmin, maxErrRate, minErrRate, Thinc, and Thdec may each be initialized to a predetermined value.

At operation 208, the node 102 may generate a third message 116 using the adjusted code rate (a second code rate). The third message 116 may indicate the second code rate. For example, the node 102 may generate a SRB message as the third message 116, that includes a MCS, number of PRB, and number of layers that correspond to the second code rate.

At operation 210, the node 102 may send the third message 116 to the UE 104. The third message 116 may indicate the second code rate to the UE 104. For example, the node 102 may send the third message 116 to the first UE. As another example, the node 102 may send the third message 116 to a second UE that is different than the first UE.

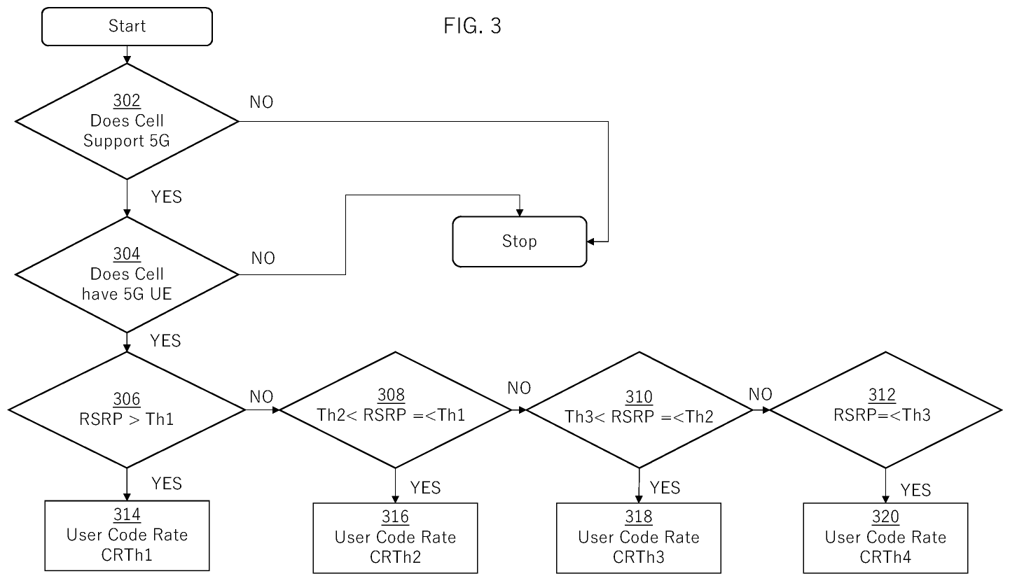

FIG. 3 illustrates a flowchart of a method for adjusting a code rate, in accordance with one or more example embodiments. Referring to FIG. 3, at operation 302, the node 102 may determine if it services a cell supporting 5G. If the node 102 determines that the cell does not support 5G, then the node 102 proceeds to stop. If the node 102 determines that the cell supports 5G, then the node 102 proceeds to operation 304.

At operation 304, the node 102 may determine if it is servicing a UE that supports 5G. If the node 102 determines that it is not servicing a UE that supports 5G, then the node 102 proceeds to stop. If the node 102 determines that it is servicing a UE that supports 5G, then the node 102 proceeds to operation 306.

At operation 306, the node 102 may determine whether a RSRP value reported by a UE is greater than a first threshold Th1. For example, the node 102 may receive a second message 114 from the UE 104. The second message 114 may include a RSRP value corresponding to the a first message 112 sent to the UE 104. The node may compare the RSRP from the second message 114 to Th1. If the node 102 determines that the RSRP value is not greater than Th1, the node 102 proceeds to operation 308. If the node 102 determines that the RSRP value is greater than Th1, the node 102 proceeds to operation 314.

At operation 308, the node 102 may determine whether the RSRP value reported by the UE is greater than a second threshold Th2. For example, the node 102 may compare the RSRP value from the second message 114 to Th2. If the node 102 determines that the RSRP value is not greater than Th2, the node proceeds to operation 310. If the node 102 determines that the RSRP value is greater than Th2, the node 102 proceeds to operation 316.

At operation 310, the node 102 may determine whether the RSRP value reported by the UE is greater than a third threshold Th3. For example, the node 102 may compare the RSRP value from the second message 114 to Th3. If the node 102 determines that the RSRP value is not greater than Th3, the node proceeds to operation 312. If the node 102 determines that the RSRP value is greater than Th3, the node 102 proceeds to operation 318.

At operation 312, the node 102 may determine that the RSRP value reported by the UE is not greater than Th3, and the node 102 may proceed to operation 320.

At operation 314, the node 102 may adjust a code rate used for communication with the UE by setting the code rate to a first user code rate CRTh1.

At operation 316, the node 102 may adjust the code rate used for communication with the UE by setting the code rate to a second user code rate CRTh2.

At operation 318, the node 102 may adjust the code rate used for communication with the UE by setting the code rate to a third user code rate CRTh3.

At operation 320, the node 102 may adjust the code rate used for communication with the UE by setting the code rate to a fourth user code rate CRTh4.

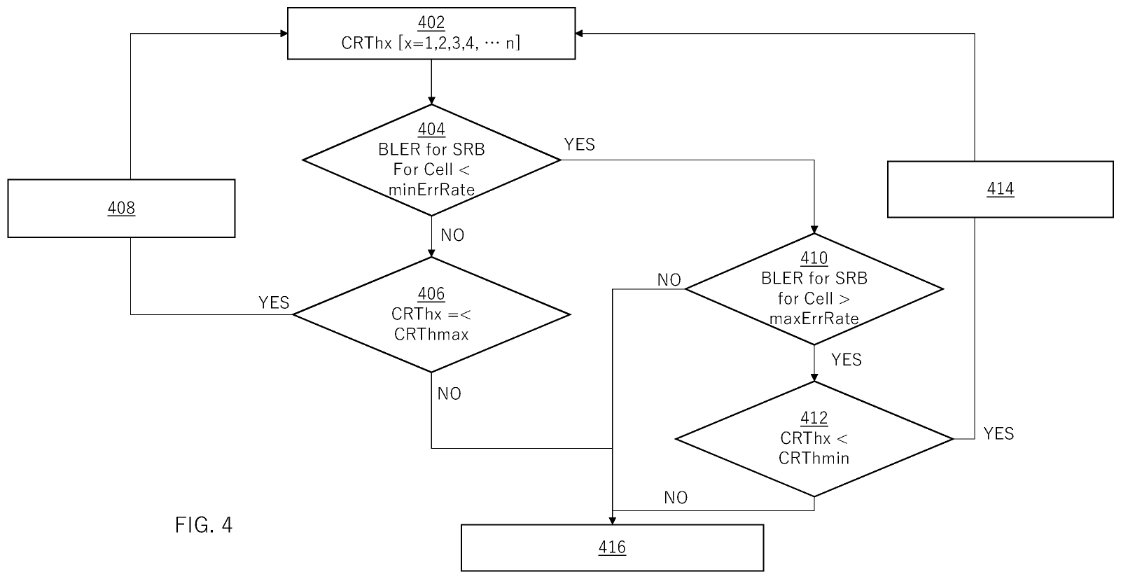

FIG. 4 illustrates a flowchart of a method for adjusting a code rate, in accordance with one or more example embodiments. Referring to FIG. 4, the node 102 may perform the method 400 for each of one or more user code rates. For example, the node 102 may perform the method 400 for each of the user code rates CRTh1, CRTh2, CRTh3, and CRTh4. In some implementations, the node 102 may perform the method 400 sequentially for each of the one or more user code rates. For example, the node 102 may perform the method 400 for CRTh1, then perform the method 400 for CRTh2, then perform the method 400 for CRTh3, and then perform the method 400 for CRTh4. In some implementations, the node 102 may perform the method 400 simultaneously for each of the one or more user code rates. For example, the node 102 may perform the method 400 for each of CRTh1, CRTh2, CRTh3, and CRTh4 in parallel.

At operation 402, the node 102 may select one of the user code rates (e.g., CRThx, where x corresponds to the selected user code rate). For example, the node 102 may select one of CRTh1, CRTh2, CRTh3, and CRTh4. After selecting the user code rate CRThx, the node 102 proceeds to operation 404.

At operation 404, the node 102 may determine if a BLER for SRB messages in the cell is less than a first threshold error rate minErrRate. If the BLER is less than minErrRate, the node 102 proceeds to operation 406. If the BLER is greater than minErrRate, the node 102 proceeds to operation 410.

At operation 406, the node 102 may determine if the selected user code rate (CRThx) is less than or equal to a maximum code rate CRThmax. If the node 102 determines that CRThx is less than or equal to CRThmax, the node 102 proceeds to operation 408. If the node 102 determines that CRThx is greater than CRThmax, the node 102 proceeds to operation 416.

At operation 408, the node 102 may adjust the selected user code rate (CRThx). For example, the node 102 may increment CRThx by a threshold value Thinc. After adjusting the code rate, the node 102 proceeds to operation 402.

At operation 410, the node 102 may determine if the BLER for SRB messages in the cell is greater than a second threshold error rate maxErrRate. If the BLER is greater than maxErrRate, the node 102 proceeds to operation 412. If the BLER is not greater than maxErrRate, the node 102 proceeds to operation 416.

At operation 412, the node 102 may determine if the selected user code rate (CRThx) is less than a minimum code rate CRThmin. If the node 102 determines that CRThx is greater than CRThmin, the node 102 proceeds to operation 414. If the node 102 determines that CRThx is not greater than CRThmin, the node 102 proceeds to operation 416.

At operation 414, the node 102 may adjust the selected user code rate (CRThx). For example, the node 102 may decrement CRThx by a threshold value Thdec. After adjusting the code rate, the node 102 proceeds to operation 402.

At operation 416, the node 102 may determine not to adjust the selected user code rate (CRThx), and the node 102 proceeds to operation 402.

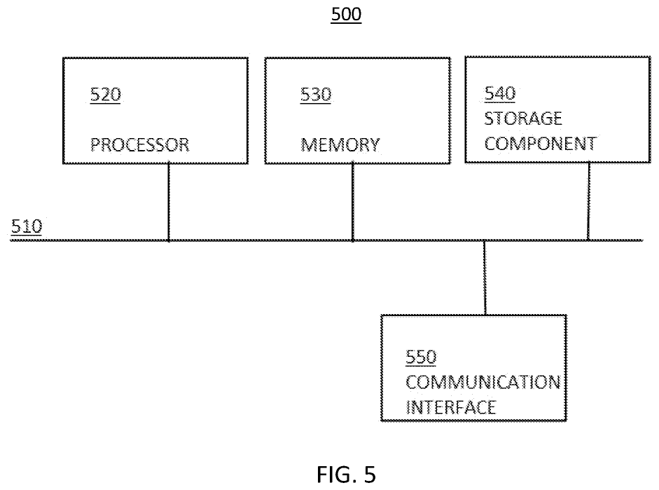

FIG. 5 illustrates a diagram of components of one or more devices, in accordance with one or more example embodiments. Device 500 may correspond to any of the devices described above (e.g., UE, base station, RAN node, core network device implementing core network function).

Referring to FIG. 5, the device 500 may include a bus 510, a processor 520, a memory 530, a storage component 540, and a communication interface 550. It is understood that one or more of the components may be omitted and/or one or more additional components may be included.

The bus 510 includes a component that permits communication among the components of the device 500. The processor 520 is implemented in hardware, firmware, or a combination of hardware and software. The processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 520 includes one or more processors capable of being programmed to perform a function.

The memory 530 includes a random access memory (RAM), a read only memory (ROM), and/or another type of dynamic or static storage device (e.g., a flash memory, a magnetic memory, and/or an optical memory) that stores information and/or instructions for use by the processor 520.

The storage component 540 stores information and/or software related to the operation and use of the device 500. For example, the storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The communication interface 550 includes a transceiver-like component (e.g., a transceiver and/or a separate receiver and transmitter) that enables the device 900 to communicate with other devices, such as via a wired connection, a wireless connection, or a combination of wired and wireless connections. The communication interface 550 may permit device 500 to receive information from another device and/or provide information to another device. For example, the communication interface 550 may include an Ethernet interface, an optical interface, a coaxial interface, an infrared interface, a radio frequency (RF) interface, a universal serial bus (USB) interface, a Wi-Fi interface, a cellular network interface, or the like.

The device 500 may perform one or more processes or functions described herein. The device 500 may perform operations based on the processor 520 executing software instructions stored by a non-transitory computer-readable medium, such as the memory 530 and/or the storage component 540. A computer-readable medium is defined herein as a non-transitory memory device. A memory device includes memory space within a single physical storage device or memory space spread across multiple physical storage devices.

Software instructions may be read into the memory 530 and/or the storage component 540 from another computer-readable medium or from another device via the communication interface 550. When executed, software instructions stored in the memory 530 and/or storage component 540 may cause the processor 520 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any one of the operations or processes of FIGS. 2-4 may be implemented by or using any one of the elements illustrated in FIGS. 1 and 5.

According to example embodiments, a RAN node may perform adaptive resource handling using a signal radio bearer (SRB) message. For instance, the node may determine a RF condition of an environment between the node and a UE, based at least in part on prior communication with the UE, and adjust a code rate used for communication with the UE based on the determined RF condition. If the RF condition is good, then the node may increase the code rate. If the RF condition is poor, then the node may decrease the code rate. The node may generate a SRB message using the adjusted code rate, and may send the SRB message to the UE in order to communicate the adjusted code rate to the UE. By performing adaptive resource handling, improved efficiency may be achieved in both good RF conditions and poor RF conditions.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for adaptive signal radio bearer (SRB) resource handling by a radio access network (RAN) node, the method comprising:
sending a first message to a user equipment (UE);
receiving a second message from the UE in response to the first message, the second message including one or more parameters indicating a radio frequency (RF) condition between the RAN node and the UE, the RF condition reported by the UE;
adjusting a code rate for the UE based at least in part on the RF condition between the RAN node and the UE;
generating a SRB message using the adjusted code rate; and
sending the SRB message to the UE or to one or more other UEs.

2. The method of claim 1, wherein the adjusting the code rate for the UE, based at least in part on the RF condition reported by the UE, further comprises:
adjusting the code rate for the UE to a first code rate, in response to determining that the RF condition exceeds a first threshold;
adjusting the code rate for the UE to a second code rate, in response to determining that the RF condition exceeds a second threshold and is less than or equal to the first threshold; and
adjusting the code rate for the UE to a third code rate, in response to determining that the RF condition exceeds a third threshold and is less than or equal to the second threshold.

3. The method of claim 1, wherein the adjusting the code rate for the UE, based at least in part on the RF condition reported by the UE, further comprises:
determining a RF condition threshold that is less than the RF condition reported by the UE;
determining a code rate corresponding to the RF condition threshold; and
adjusting the code rate for the UE to the code rate corresponding to the RF condition threshold.

4. The method of claim 3, wherein the adjusting the code rate for the UE, based at least in part on the RF condition reported by the UE, further comprises:
determining a signaling message error rate for a cell corresponding to the RAN node;
increasing the code rate by a predetermined increment, in response to determining that the signaling message error rate for the cell is less than a minimum error rate and the code rate is less than or equal to a maximum code rate; and
decreasing the code rate by a predetermined decrement, in response to determining that the signaling message error rate for the cell is greater than a maximum error rate and the code rate is greater than a minimum code rate.

5. The method of claim 4, wherein the determining the signaling message error rate for the cell corresponding to the RAN node further comprises:
receiving a plurality of second messages from a plurality of UEs; and
determining a ratio of a number of second messages that include a NACK parameter to a total number of second messages received.

6. The method of claim 1, wherein the one or more parameters in the second message include at least a first parameter representing a reference signal received power (RSRP), and wherein the RF condition between the RAN node and the UE is based at least in part on the first parameter.

7. The method of claim 6, wherein the one or more parameters in the second message further include at least a second parameter representing channel quality information (CQI) and a third parameter representing a rank indicator (RI), and the first parameter is a function of the second parameter and the third parameter.

8. An apparatus for performing adaptive signal radio bearer (SRB) resource handling by a radio access network (RAN) node, the apparatus comprising:
a memory storing instructions; and
at least one processor configured to execute the instructions to:
send a first message to a user equipment (UE);
receive a second message from the UE in response to the first message, the second message including one or more parameters indicating a radio frequency (RF) condition between the RAN node and the UE, the RF condition reported by the UE;
adjust a code rate for the UE based at least in part on the RF condition between the RAN node and the UE;
generate a SRB message using the adjusted code rate; and
send the SRB message to the UE or to one or more other UEs.

9. The apparatus of claim 8, wherein the adjusting the code rate for the UE, based at least in part on the RF condition reported by the UE, further comprises:
adjusting the code rate for the UE to a first code rate, in response to determining that the RF condition exceeds a first threshold;
adjusting the code rate for the UE to a second code rate, in response to determining that the RF condition exceeds a second threshold and is less than or equal to the first threshold; and
adjusting the code rate for the UE to a third code rate, in response to determining that the RF condition exceeds a third threshold and is less than or equal to the second threshold.

10. The apparatus of claim 8, wherein the adjusting the code rate for the UE, based at least in part on the RF condition reported by the UE, further comprises:
determining a RF condition threshold that is less than the RF condition reported by the UE;
determining a code rate corresponding to the RF condition threshold; and
adjusting the code rate for the UE to the code rate corresponding to the RF condition threshold.

11. The apparatus of claim 10, wherein the adjusting the code rate for the UE, based at least in part on the RF condition reported by the UE, further comprises:
determining a signaling message error rate for a cell corresponding to the RAN node;
increasing the code rate by a predetermined increment, in response to determining that the signaling message error rate for the cell is less than a minimum error rate and the code rate is less than or equal to a maximum code rate; and
decreasing the code rate by a predetermined decrement, in response to determining that the signaling message error rate for the cell is greater than a maximum error rate and the code rate is greater than a minimum code rate.

12. The apparatus of claim 11, wherein the determining the signaling message error rate for the cell corresponding to the RAN node further comprises:
receiving a plurality of second messages from a plurality of UEs; and
determining a ratio of a number of second messages that include a NACK parameter to a total number of second messages received.

13. The apparatus of claim 8, wherein the one or more parameters in the second message include a at least a first parameter representing a reference signal received power (RSRP), and wherein the RF condition between the RAN node and the UE is based at least in part on the first parameter.

14. The apparatus of claim 13, wherein the one or more parameters in the second message further include at least a second parameter representing channel quality information (CQI) and a third parameter representing a rank indicator (RI), and the first parameter is a function of the second parameter and the third parameter.

15. A non-transitory computer-readable medium for storing computer readable program code or instructions for carrying out operations, when executed by a processor, for adaptive signal radio bearer (SRB) resource handling by a radio access network (RAN) node, the operations comprising:
sending a first message to a user equipment (UE);
receiving a second message from the UE in response to the first message, the second message including one or more parameters indicating a radio frequency (RF) condition between the RAN node and the UE, the RF condition reported by the UE;
adjusting a code rate for the UE based at least in part on the RF condition between the RAN node and the UE;
generating a SRB message using the adjusted code rate; and
sending the SRB message to the UE or to one or more other UEs.

16. The non-transitory computer-readable medium of claim 15, wherein the adjusting the code rate for the UE, based at least in part on the RF condition reported by the UE, further comprises:
adjusting the code rate for the UE to a first code rate, in response to determining that the RF condition exceeds a first threshold;
adjusting the code rate for the UE to a second code rate, in response to determining that the RF condition exceeds a second threshold and is less than or equal to the first threshold; and
adjusting the code rate for the UE to a third code rate, in response to determining that the RF condition exceeds a third threshold and is less than or equal to the second threshold.

17. The non-transitory computer-readable medium of claim 15, wherein the adjusting the code rate for the UE, based at least in part on the RF condition reported by the UE, further comprises:
determining a RF condition threshold that is less than the RF condition reported by the UE;
determining a code rate corresponding to the RF condition threshold; and
adjusting the code rate for the UE to the code rate corresponding to the RF condition threshold.

18. The non-transitory computer-readable medium of claim 17, wherein the adjusting the code rate for the UE, based at least in part on the RF condition reported by the UE, further comprises:
determining a signaling message error rate for a cell corresponding to the RAN node;
increasing the code rate by a predetermined increment, in response to determining that the signaling message error rate for the cell is less than a minimum error rate and the code rate is less than or equal to a maximum code rate; and
decreasing the code rate by a predetermined decrement, in response to determining that the signaling message error rate for the cell is greater than a maximum error rate and the code rate is greater than a minimum code rate.

19. The non-transitory computer-readable medium of claim 18, wherein the determining the signaling message error rate for the cell corresponding to the RAN node further comprises:
receiving a plurality of second messages from a plurality of UEs; and
determining a ratio of a number of second messages that include a NACK parameter to a total number of second messages received.

20. The non-transitory computer-readable medium of claim 15, wherein the one or more parameters in the second message include a at least a first parameter representing a reference signal received power (RSRP), and wherein the RF condition between the RAN node and the UE is based at least in part on the first parameter.
